(19) United States
(12) Patent Application Publication
(10) Pub. No.: US 2008/0268273 A1
(43) Pub. Date: Oct. 30, 2008

(54) WOOD VENEER SURFACED DECORATIVE LAMINATE PRODUCT AND METHOD OF MAKING SAME

(75) Inventors: Kevin Francis O'Brien, Cincinnati, OH (US); Bryce Lamar Cole, Mason, OH (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: THE DILLER CORPORATION, Cincinnati, OH (US)

(21) Appl. No.: 11/739,308

(22) Filed: Apr. 24, 2007

(51) Int. Cl. B32B 21/08; B05D 3/02

(52) U.S. Cl. 428/528; 427/385.5

(57) ABSTRACT

A wood veneer surfaced laminate and method of making it are provided which produces a product having the appearance of a natural wood product, but with the toughness, moisture resistance, stain resistance, impact resistance, and abrasion resistance of melamine resin surfaced laminate products. The wood veneer surfaced laminate is made by providing a sheet of a natural or engineered wood veneer; impregnating the sheet with a first liquid curable resin such that said liquid resin substantially completely impregnates the sheet; coating a second liquid curable resin onto a surface of the sheet; laminating the sheet to a core while curing the resins to form a natural or engineered wood veneer surfaced laminate.

### BACKGROUND OF THE INVENTION

The present invention relates to wood veneer surfaced laminates, including engineered wood veneer surfaced laminates, and methods of making such laminates for use as decorative surfacing materials for countertops, cabinets, furniture, wall coverings, and other applications.

Decorative laminates are known in the art for use as surfaces for countertops, table tops, furniture, and the like. Such decorative laminates are typically comprised of a core, formed from a plurality of kraft paper sheets which are impregnated with a resin. Positioned above the core is a decorative sheet which is typically a pigmented cellulose paper containing a printed pattern design, or alternatively a solid color paper, which may also be impregnated with a resin. The decorative sheet, in the case of a print, is generally covered with a transparent or semi-transparent protective overlay sheet comprising a cellulose paper impregnated with a resin such as a melamine-formaldehyde resin, or modified melamine-formaldehyde resin, generically referred to as a “melamine resin.” The overlay sheet protects the decorative sheet from abrasion, scratches, chemicals, burns, and the like. The decorative laminates are typically made by stacking the core sheets, decorative sheet, and overlay sheet together, inserting the collated stack between press plates, and then applying a temperature and pressure sufficient to cause the laminating resins to flow between the respective layers and subsequently cure.

In some applications, the decorative sheet is printed with a woodgrain pattern to simulate a wood surface. However, while such laminated products provide excellent scratch and abrasion resistance, it is apparent to end users that such laminates do not contain a natural wood surface.

Efforts have been made to incorporate natural wood veneers into such laminated products. Typically, a thin wood veneer is bonded to a kraft paper core, which core has been impregnated with a resin. The wood is then coated with a lacquer, such as, for example, a lacquer containing polyurethane and/or polyacrylate or polymethacrylate resins. To build up the protective lacquer coating, the wood veneer surface is repeatedly coated, dried, sanded, recoated, etc. While such laminates provide realistic woodgrain surfaces, the lacquers used to coat the veneer do not provide the tough, abrasion and impact resistant surface that conventional decorative laminates with a cured melamine resin surface possess. Such laminates are typically limited to use on vertical surfaces such as cabinets and wall coverings. Further, the necessity of repeatedly applying, drying, and sanding the coating adds substantially to the cost of producing such laminates.

Attempts to coat a wood veneer with melamine resin, or surface a wood veneer with a melamine resin impregnated overlay paper, have not been altogether successful, as the finished laminate products are subject to delamination at the melamine resin-wood interface. That is, the resin does not penetrate the surface of the wood veneer sufficiently to form a durable bond. Also, such products cannot be readily postformed as can conventional laminates, due to cracking of the veneer and delamination of the layers during the postforming process. Furthermore, with use of a melamine resin treated overlay, the natural color fidelity of the wood grain tends to be washed out,

Engineered wood veneers are known in the art. For example, Senzani in GB 2,236,708, and Senzani in U.S. Pat. No. 5,145,537, teach methods of producing engineered wood veneer. Thin sheets of wood are cut and dyed, and then stacked and laminated into wood blocks. The wood blocks are then sliced at various angles to obtain thin veneers having distinctive grain pattern designs.

However, there has heretofore remained a need in the art for a wood veneer laminated product that provides the visual effects of a natural wood product while exhibiting the abrasion and impact resistance, as well as the postformability with prerequisite heat resistance, of melamine resin surfaced laminate products.

### BRIEF SUMMARY OF THE INVENTION

The present invention addresses that need by providing a wood veneer surfaced laminate, and method of making such laminate which produces a product having the appearance of natural wood, but with the toughness, impact resistance, and abrasion resistance of melamine resin surfaced laminate products.

In accordance with one embodiment of the present invention, a method of making a wood veneer surfaced laminate is provided and includes providing a sheet of a natural or engineered wood veneer; impregnating the sheet with a first liquid curable resin such that said liquid resin substantially completely impregnates the sheet; coating a second liquid curable resin onto a surface of the sheet; laminating the sheet to a core to form a natural or engineered wood veneer surfaced laminate with curing of the first and second resins. Where a natural wood veneer is used, the wood can be selected from oak, beech, maple, mahogany, obeche, or the like. Alternatively, an engineered wood veneer, such as those available commercially from ALPI SpA of Modigliana, Italy, may be used. Such wood veneer sheets, whether natural or engineered, are inherently thin and fragile.

In a preferred embodiment, the first liquid curable resin comprises an aqueous melamine-formaldehyde resin solution composition that has been modified by the addition of plasticizers and surfactants so that the liquid composition more readily wets and penetrates into the wood veneer sheet. Typically, as will be understood by those skilled in the art, melamine-formaldehyde resins are the condensation polymerization reaction products of melamine, and possibly another amino-functional comonomer or “internal” plasticizer, with a molar excess of formaldehyde in aqueous solution under slightly basic conditions to the onset of their water hydrophobicity. While not wishing to be bound by any specific theory, the addition of hydroxyl-functional “external” plasticizers and surfactants is believed to lower both the viscosity and surface tension of the liquid resin composition. The first curable resin is preferably coated onto both the top and bottom surfaces of the wood veneer sheet, where it is permitted to substantially completely penetrate the entire thickness of the sheet. Typically, the first liquid curable resin is permitted to penetrate into the sheet for approximately 10 to 60 minutes, and preferably approximately 20 to 40 minutes, to substantially completely penetrate the sheet. The sheet is then optionally dried prior to coating the second liquid curable resin onto the sheet.

A second liquid curable resin such as, for example, an aqueous melamine-formaldehyde resin solution, is then coated onto a surface of the wood veneer sheet which has been impregnated with the first liquid curable resin. Typically, the second liquid curable resin includes additives such as, for example, a catalyst for accelerating the cure rate of the second resin as well as oxide particles to impart enhanced abrasion resistance to the finished laminate surface.

The core of a high pressure decorative laminate typically comprises one or more sheets of heat curable resin impregnated kraft paper. The resin impregnated and coated wood veneer sheet is laminated to the core by positioning the wood veneer sheet and the core material between a pair of press plates and applying pressure thereto. The press plates are then heated under pressure to a predetermined temperature for sufficient time to cure the first and second resins, as well as the core resin, such pressing process being well understood by those versed in the art. The application of heat and pressure, typically employing a flat bed hydraulic press of one or more openings, equipped with heating/cooling platens, causes the resins to flow and bond all of the layers of the laminate together to form a strong, unitary product. Optionally, a grain structure may be imparted to the decorative surface of the laminate by providing at least one press plate with a woodgrain surface texture, where the applied pressure embosses the decorative wood veneer surface of the laminate during the pressing and curing operation.

The finished laminate, after edge trimming and back sanding, can then be bonded, using a suitable adhesive, to a substrate selected from materials such as medium density fiberboard, particleboard, plywood, oriented strand board, wafer board, mineral fiber cement board, or the like, which imparts mechanical strength to the decorative laminate in final panel assembly form. The finished laminate product provides the visual effects of a natural wood product, while at the same time providing the toughness, moisture resistance, stain resistance, impact resistance, and abrasion resistance of a conventional melamine resin surfaced laminated product. The finished laminate product may be postformed by heating the laminate and forming at least a portion of the laminate around a forming mold. The laminate product may be so postformed without causing delamination of the product, or cracking of the wood veneer surface.

In accordance with the above, another embodiment of the present invention comprises a wood veneer surfaced laminate panel assembly, where the wood veneer surfaced decorative laminate is subsequently bonded to a substrate, with the natural or engineered wood veneer being impregnated with a melamine resin such that the melamine resin has substantially completely impregnated the sheet, with an additional melamine resin layer coating the natural or engineered wood veneer. The wood veneer may comprise, for example, either a natural wood veneer such as oak or beech, or may comprise an engineered wood veneer. Preferably, the wood veneer laminate product, used to surface the panel assembly, is made by the process as described above.

Accordingly, it is a feature of the embodiments of the present invention to provide a wood veneer decorative laminate and method of making such decorative laminate, which produces a product having the appearance of a natural wood product, but with the toughness, moisture resistance, stain resistance, impact resistance, and abrasion resistance of conventional melamine resin surfaced laminate products. Other features and advantages of embodiments of the present invention will be apparent from the following detailed description, the accompanying drawings, and the appended claims.

### BRIEF DESCRIPTION OF THE DRAWINGS

The following detailed description of specific embodiments of the present invention can be best understood when read in conjunction with the following drawings, where like structure is indicated with like reference numerals and in which:

FIG. 1 is a cross-sectional view of one embodiment of the wood veneer surfaced laminate of the present invention;

FIG. 2 is a cross-sectional view of another embodiment of the wood veneer surfaced laminate of the present invention;

FIG. 3 is a cross-sectional view of one embodiment of the wood veneer surfaced laminate of the present invention bonded to a substrate material, thus forming a final panel assembly of the present invention; and

FIG. 4 is a schematic illustration of a method of making one embodiment of the wood veneer surfaced laminate of the present invention.

### DETAILED DESCRIPTION OF THE PREFERRED EMBODIMENTS

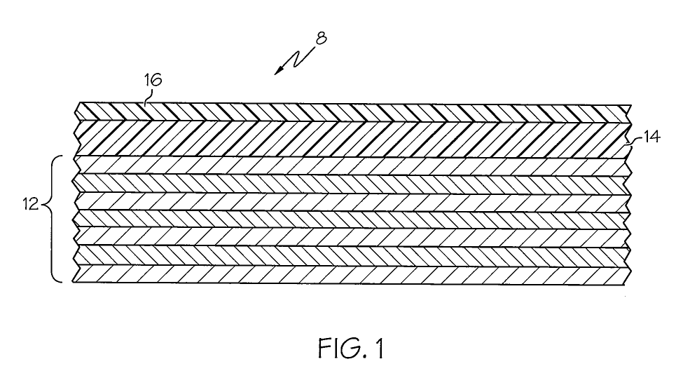

Referring initially to FIG. 1, one embodiment of the wood veneer surfaced decorative laminate 8 is shown. The laminate comprises a core 12, a sheet of wood veneer 14 that has been impregnated with resin, and a cured resin coating 16 on the wood veneer. As shown, the core 12 of the laminate is comprised of one or more layers of paper sheets, such as kraft paper, which have been impregnated with a heat curable liquid thermosetting resin such as a phenol-formaldehyde resin or a melamine-formaldehyde resin. The core provides a reinforcing structural base to the laminate.

A preferred structure for the core layer is from about 2-20 sheets of 80-250 grams per square meter (gsm) basis weight kraft paper impregnated with a phenolic resin, a melamine resin, or blends thereof. Typically, the liquid resin aqueous solution will have a solids content of from about 40 to about 70% and a water content of from about 30 to about 60%. As those versed in the art will appreciate, use of lower resin solids aqueous resin solutions to impregnate the core paper may require use of core papers with a greater amount of a wet strength agent to insure satisfactory handleability, without excessive web breaks, during the treating operation.

In a preferred embodiment, the core resin will be the same resin which is used to impregnate and penetrate the wood veneer sheet 14. It has been found that using a common resin provides additional dimensional stability to the finished laminate. Additionally, modification of such resin, and preferably a melamine resin, with a suitable “internal” and/or “external” plasticizer such as acetoguanamine, dicyanodiamide, ortho-and/or para-sulfonamide, diethylene glycol, polyethylene glycols, 2-ethoxyethanol, 2-phenoxyethanol, or the like, or combinations thereof, will improve the finished laminate flexibility, stress crack resistance, and postforming characteristics, as is known by those skilled in the art.

The wood veneer sheet 14 comprises either a natural wood veneer such as, for example, oak or beech wood, or an engineered wood veneer. For example, the sheet may be made in accordance with the process taught by Senzani in U.S. Pat. No. 5,145,537, the disclosure of which is incorporated by reference herein. Other engineered wood veneers may also be used.

Sheet 14 has preferably been saturated with a heat curable liquid melamine resin which has also been modified to increase its ability to penetrate into, and uniformly impregnate, the wood veneer sheet. A preferred liquid melamine resin composition is an aqueous reaction product comprising melamine, formaldehyde (as aqueous formalin solution), optionally other amino-functional reactive compounds such as acetoguanamine, ortho- and/or para-toluenesulfonamide, and/or dicyanodiamide internal plasticizers mentioned above, and a hydroxide or tertiary amine base reaction moderator. Post-reaction resin modifiers preferably include addition of a latent catalyst, such as a blocked amine/carboxylic acid salt, for example diethylethanolamine/acetic acid, to adjust the final cure rate of the resin, a surfactant and a high boiling alcohol or glycol external plasticizer, for example 2-phenoxyethanol or diethylene glycol, as mentioned above, which in addition to plasticizing the cured resin, also serve as wetting agents and promote the liquid resin penetrability.

Cured resin layer 16 is also preferably formed using a heat curable liquid modified melamine resin such as that described above. Alternatively, in lieu of preparing the melamine or phenolic base resin, such resins are commercially available from a number of manufacturers including Hexion Specialty Chemicals, Inc., Dynea International Oy, and Georgia-Pacific Chemicals LLC. Layer 16 may also include fine mesh oxide particles such as, for example, aluminum oxide. Such particles typically have average diameters in the range of from about 3 to about 50 microns. The coating resin composition may be prepared by mixing, with continual agitation, the alumina powder into the catalyzed and otherwise modified liquid melamine resin solution to evenly disperse the alumina particles. Additionally, a thickening agent such as sodium alginate, carboxymethyl cellulose, or the like, may be advantageously incorporated in the resin solution to aid with suspension of the alumina dispersion.

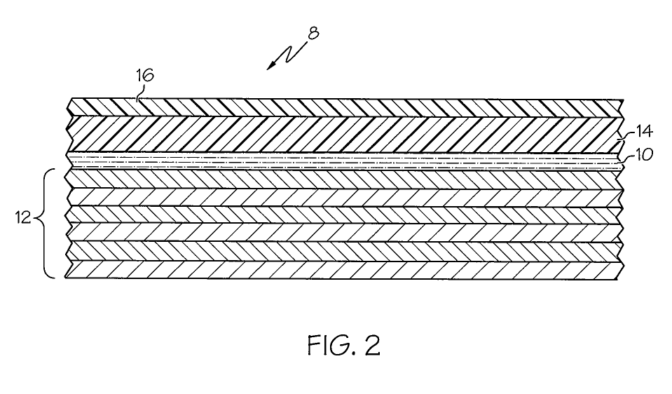

A further preferred embodiment of the present invention is illustrated in FIG. 2, where another wood veneer surfaced decorative laminate 8 is shown. The laminate comprises a wood veneer sheet 14 that has been impregnated with a heat curable resin, and a cured resin coating 16 on the wood veneer. The wood veneer surfaced laminate is further comprised of one or more plies of heat curable resin impregnated core paper 12. Additionally, a heat curable resin impregnated barrier sheet 10 may optionally be used advantageously. The wood veneers are inherently quite thin, as described above, and therefore, are not completely opaque, which is further exacerbated by the variable density of their woodgrain structure. As such, the color of the core paper layer adjacent to the veneer can influence the perceived background color of the veneer wood grain itself. This “show through” effect is particularly obvious with a light color veneer such as beech or obeche wood, and conventional phenolic resin impregnated kraft paper, which when pressed and cured, is typically medium to dark brown in color.

A heat curable resin impregnated, pigmented and/or dyed optical barrier sheet 10, having the desired color, may therefore be positioned between the back of the wood veneer sheet and the core sheets to adjust and control the perceived visual color of the veneer. It is preferred to impregnate such a barrier paper with a relatively colorless and transparent thermoset resin, such as a melamine resin, to minimize color interference. The barrier base paper can be natural kraft paper, lighter colored bleached kraft paper, or more highly refined and colorless alpha cellulose paper.

Another preferred embodiment of the present invention is to selectively use pigmented and/or dyed core papers 12, preferably in conjunction with an essentially colorless, non-interfering melamine resin, in lieu of conventional resin impregnated, and particularly phenolic resin impregnated, natural kraft core paper. Such alternative core base papers can be natural kraft paper, lighter colored bleached kraft paper, or more highly refined and colorless alpha cellulose paper, or combinations thereof. The thin wood veneer (and optionally, a barrier sheet) will typically only comprise about 20-30% of the total thickness of the pressed laminate, with the remainder being the underlying core. Particularly when the finished wood veneer surfaced laminate has been adhered to a substrate, and the laminate edge machined by routing or other suitable means, a large color disparity between the laminate edge's veneer surface and core sections can be quite evident and aesthetically objectionable. Therefore, a color coordinated or “color matched” core can be used advantageously to achieve a “through color” edge appearance, and the perception of a solid, thick wood veneer, rather than a thin wood veneer laminate. As such, said resultant edge appearance can be more natural and pleasing in simulating a real wood product.

Such colored core paper sheets can be used in conjunction with a different color barrier sheet adjacent to the wood veneer, or without an intermediate barrier layer. The colored, resin treated barrier and core sheets can be obtained by using a pigmented and/or dyed paper in conjunction with a clear resin, or conversely, non-pigmented base papers can be impregnated with a pigmented and/or dyed resin, or a combination thereof.

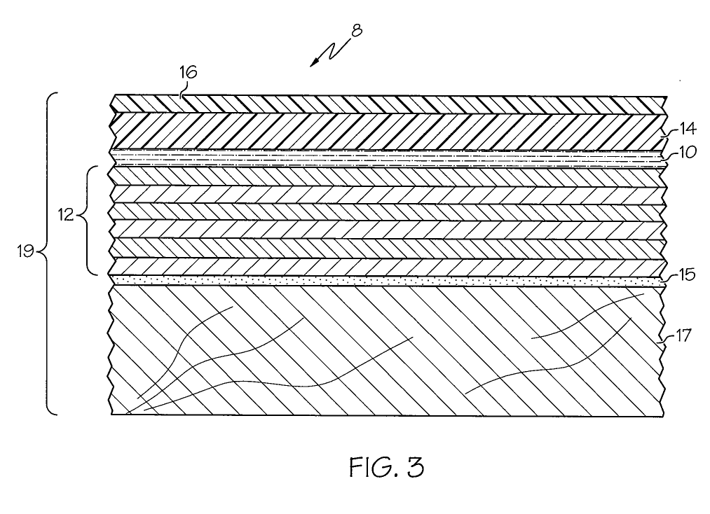

FIG. 3 illustrates a preferred embodiment of the wood veneer surfaced decorative laminate 8 of the present invention, in which said laminate has been bonded by means of a suitable adhesive 15 to a substrate material 17, thus forming a bonded panel assembly 19. Suitable adhesives 15, typically brushed, rolled or sprayed on to the sanded back of the decorative laminate 8 and/or the opposed surface of the substrate 17, include neoprene-based contact adhesives, catalyzed or uncatalyzed polyvinylacetate (PVAc) cold or hot press adhesives, or thermosetting adhesives such as urea-formaldehyde or phenol-resorcinol-hexamethylenetetraamine adhesives, depending on the final end-use panel application. Preferred substrate materials 17 include 45 pound/ft³ particleboard, medium density fiberboard (MDF) or cement fiberboard, again depending on the panel assembly end-use performance requirements. Other types of substrates, for example fire-rated particleboard, aluminum, steel, fiber reinforced polyester (FRP), and honeycomb sheet materials, may also be used for more specialized applications.

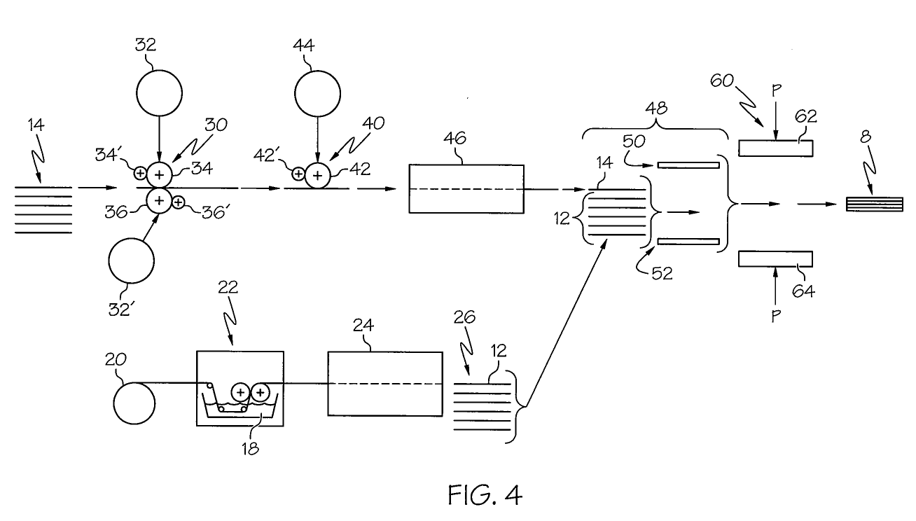

FIG. 4 illustrates an embodiment of the method of making the wood veneer surfaced laminate of the present invention. While shown as a substantially continuous process, it is also possible that individual components in the laminate may be prepared at separate times, and even at separate locations, prior to being pressed into the final laminate product. As shown, multiple sheets of core 12 are formed by impregnating a continuous web of kraft or other selected paper 20, as described above, with a liquid resin 18 at treating station 22, followed by at least partial drying in an oven 24, which is typically a recirculated hot air heated oven. The impregnated and partially dried paper web is then cut to size, and the core sheets 12 stacked at station 26.

The core papers will typically vary in basis weight from about 80 up to about 250 grams per square meter (gsm), or from about 50 up to about 150 pounds per 3000 square feet (ream), and are normally treated, i.e., impregnated and partially dried, to a resin content of from about 25% up to about 45%, with a residual volatile content of from about 4% up to about 10%. As used herein, the term “resin content” is defined as the difference in weight of a given area of the treated paper and the initial untreated paper, divided by the weight of the treated paper and expressed as a percentage. Similarly, as used herein, the term “volatile content” is defined as the difference in weight of a given area of the treated paper and the same treated paper sample after complete drying at 165° C. for 5 minutes, divided by the weight of the treated paper and expressed as a percentage. As a preferred embodiment of the present invention, a Mead/Westvaco 158 gsm (97 lb./ream) pigmented core paper, with a moisture content of about 2% and an ash content of about 25%, is treated to about 40% resin content and 5% volatile content for subsequent use as the core plies 12 in the wood veneer decorative laminate of the present invention.

Typically, the decorative laminate of the present invention is provided in the form of a sheet having predetermined dimensions as desired. Generally, such sheets have widths of between about 36 and 72 inches (about 90 to 185 cm.) and lengths of between about 72 and 144 inches (about 185 to 370 cm.), conforming to the size of the press plates in use and limited only by the size of the press heating/cooling platens. The core sheets 12 are sized to match the veneer dimensions in forming the final laminate product of predetermined size.

Again referring to FIG. 4, the wood veneer sheets 14 are provided in stack form and fed individually to a first coating station 30. The sheets may be a natural wood or an engineered wood veneer product. Typically, such sheets are provided with a basis weight of from about 250 to about 350 grams per square meter (about 0.05 to 0.07 pounds per square foot), and a thickness of from about 0.45 to about 0.60 mm. (about 0.018 to about 0.024 inch). As discussed above, the sizes of the veneer sheets may vary in overall width and length as desired.

Coating station 30 preferably includes infeed and outfeed conveyors and two applicator rolls, 34 and 36, each provided with an adjustable position, variable pressure doctor roll 34′ and 36′ respectively to meter the liquid resin on the applicator rolls and therefore control the resin application rate. One applicator roll 34 is positioned to apply liquid resin to the top surface of the wood veneer sheet, and the other applicator roll 36 is positioned to supply liquid resin to the bottom surface of the wood veneer sheet. At coating station 30, a first liquid heat curable resin is supplied to the two applicator rolls from separate resin sources 32 and 32′. Alternatively, a single resin source may be used that includes separate supply lines to each applicator roll. In one embodiment, the applicator rolls comprise polyurethane foam surfaced stainless steel rolls, and the doctor rolls comprise knurled chrome-plated stainless steel rolls. Suitable dual roll coaters are commercially available that can be modified as required to apply the first liquid curable resin solution application of the present invention as prescribed. The wood veneer sheet passes between the nip of applicator rolls 34 and 36 as resin is applied to both its top and bottom surfaces simultaneously.

The top and bottom applicator rolls at coating station 30 apply the first resin solution simultaneously to both faces of the wood veneer sheet in about equal proportions, with the total quantity of liquid resin deposition being from about 25% up to about 30% by weight of the veneer sheet, prior to optional partial drying. It will be appreciated by those versed in the art that the corresponding quantity of resin solids deposited onto, and with sufficient penetration time substantially into, the wood veneer sheet will be related to the solids content of the resin, and the penetration characteristics of a particular resin solution and variety of wood veneer respectively.

The rate of resin absorption will be affected by such variables as the resin molecular weight and wood density. The total quantity of liquid, and therefore solid, resin deposition can be adjusted manually by varying the doctor roll distance from, or pressure on, the applicator roll. Other application methods can also be used effectively. The prime consideration a the first coating stage of the process is to obtain essentially complete impregnation of the wood veneer sheet with a predetermined quantity of resin solids, preferable about 12% to 15% by weight of the veneer sheet.

In a preferred embodiment of the present invention, the first liquid heat curable resin comprises a melamine-formaldehyde resin that has been modified so that it will substantially completely penetrate and impregnate the thickness of the veneer sheet. Such an aqueous melamine resin solution includes melamine, formaldehyde, optionally other reactive amino compounds as internal plasticizers, a basic reaction inhibitor, optionally hydroxyl-functional or other external plasticizers and wetting agents, surfactants and a curing catalyst, as described previously. While not wishing to be bound by any particular theory, it is believed that the liquid resin penetrates substantially the entire volume of the wood veneer sheet through a capillary action mechanism.

After the wood veneer sheet 14 has passed between the applicator rolls 34 and 36 and has had sufficient liquid resin applied to both surfaces, the sheet is held or transferred off-line for a period of time sufficient for the resin to substantially completely penetrate the sheet. A secondary conveyor and stacking system (not shown) may be used to transport the treated sheets to a holding area, and then to transfer them back onto the main conveyor system later for further processing. Typically, resin penetration is complete in about 20-40 minutes. Optionally, after impregnation is complete, the sheets may subsequently be subjected to an intermediate drying operation (not shown) to remove excess water from said sheets.

After impregnation by the first resin, wood veneer sheet 14 is conveyed to a second coating station 40 where a second liquid heat curable resin is applied to the top surface of the sheet. Again, the coating station includes infeed and outfeed conveyors and an applicator roll 42 with an adjustable position, variable pressure doctor roll 42′, and is provided with a source 44 of the second resin solution. In one embodiment, the applicator roll is a polyurethane foam surfaced stainless steel roll, and the doctor roll is a knurled chrome-plated stainless steel roll. During this second, top coating stage of the process, about 8% up to about 15% by weight liquid resin based on the weight of the initial untreated veneer sheet, is applied on the surface of the impregnated veneer sheet, corresponding to a dry coating weight of about 4% up to about 8% resin solids.

In a preferred embodiment of the present invention, the second liquid heat curable aqueous melamine resin solution includes melamine, formaldehyde, optionally other reactive amino compounds as internal plasticizers, a basic reaction inhibitor, optionally hydroxyl-functional or other external plasticizers and wetting agents, surfactants and a curing catalyst, as described previously. The coating resin solution may also include oxide particles, which enhance the mar resistance, scratch resistance and abrasion resistance of the veneer surface coating. The plasticizers incorporated into the resin formulation improve the toughness and impact resistance of said coating, while the improved moisture resistance and stain resistance are inherent to melamine based resins compared to the polyester or urethane acrylate veneer coatings of the prior art.

After a coating of the second resin is applied to the wood veneer sheet, the sheet is then passed through a drying oven 46 to remove excess water, and finally the resin impregnated and coated wood veneer sheet 14 is stacked prior to use. Preferably, the resin treated veneer is partially dried to a volatile (moisture) content of from 4% to 7%. In one embodiment, the drying oven is an infrared oven that includes a vacuum belt conveyor to hold the sheet flat and prevent curling during drying.

After drying, the resin impregnated and coated wood veneer sheet 14 is combined with one or more core sheets 12, with the superimposed collated laminate components positioned between press plates 50 and 52 at the press build-up station 48, preparatory to pressing. The assembled press pack so built, consisting of the press plates and laminate components sandwiched between them, is subsequently inserted into a flat bed hydraulic press 60 between heating/cooling platens 62 and 64, where under sufficient pressure and heat, the resins in the individual laminate layers flow, cure and bond together, forming the consolidated, unitary finished wood veneer surfaced decorative laminate 8 in accordance with an embodiment of the present invention.

As a preferred embodiment of the present invention, a press plate 50 is provided with a woodgrain surface texture on at least one face directed towards, and in contact with, the surface of the coated wood veneer sheet 14, so as to emboss a grain structure into the decorative surface of the laminate during the pressing and curing operation. Alternatively, a relatively smooth, non-textured press plate 50 may be used in conjunction with a texturing/release material inserted between the press plate 50 and the coated wood veneer surface sheet 14 prior to pressing, in which the texturing/release material is typically a paper-based sheet coated on one side with a textured woodgrain design and comprising a cured, non-flowable polymer composition. The texturing/release sheet is thus used to emboss a grain structure into the decorative surface of the laminate during the pressing and curing operation and is subsequently stripped off the surface of the pressed laminate after discharge from the press and separation from the press plates. Suitable texturing/release papers are commercially available from a number of manufacturers, including S.D. Warren Co. (SAPPI), Westbrook, Me. and Wurttemb Kunststoff Plattenwerke GmbH (WKP), Unterensingen, Germany.

Press plates useful in the practice of embodiments of the present invention are typically comprised of a heat treatable and heat hardenable martensitic stainless steel alloy such as AISI 410, which can be optionally chrome plated to enhance their wear resistance and releasability from the laminate surface. A texture, such as a woodgrain design, is typically provided to the surfaces of the stainless steel press plates by means of a chemical etching process. Those versed in the art will appreciate that other types of press plates, and particularly textured press plates, may be used, including press plates comprised of tempered aluminum alloys, anodized tempered aluminum alloys, and phenolic resin/kraft paper composite laminate plates, commonly referred to as “caul plates”, where at least the latter are generally used in conjunction with a release or texturing/release media.

A typical press cycle would sequentially entail pressurizing the press (and press pack therein) to a specific pressure of about 70 kg/cm² to 100 kg/cm² (1000 psig to 1400 psig), heating the press pack in about 20 minutes to a top cure temperature of about 128° C. to 136° C. (262° F. to 277° F.), holding the predetermined cure temperature for about an additional 10 to 30 minutes, and preferably about 20 minutes at about 132° C., and then cooling the press pack in about 20 minutes to about 70° C. or less before depressurizing and opening the press to discharge the press pack containing the laminate product 8 of the present invention. Said pressed laminate is subsequently edge trimmed to the desired final dimensions and back sanded to the desired final thickness.

It will be understood by those skilled in the art that the optimum press cycle time and temperature is governed by the cure rate kinetics of the resins employed, such that the pressed finished laminate product meets certain minimum physical property standards indicating commercially acceptable laminate surface and core cure, and interlaminar bond integrity, for horizontal postforming grade HGP product. These performance standards are defined by the National Electrical Manufacturers Association (NEMA) in their Standards Publication LD 3-2005 (as approved by the American National Standards Institute (ANSI)), and include boiling water resistance (LD 3-3.5), high temperature resistance (LD 3-3.6), radiant heat resistance (LD 3-3.10), and blister resistance (LD 3-3.15), as well as those properties where the present invention exhibits substantial improvement over wood veneer surfaced laminate products of the prior art, including scratch resistance (LD 3-3.7), impact resistance (LD 3-3.8), wear (abrasion) resistance (LD 3-3.13), and [post]formability (LD 3-3.14).

It is noted that terms like “preferably” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A method of making a wood veneer surfaced laminate comprising,
providing a sheet of a natural or engineered wood veneer;
impregnating said sheet with a first liquid curable resin such that said liquid resin substantially completely penetrates said sheet;
coating a second liquid curable resin onto a surface of said sheet;
laminating said sheet to a core to form a natural or engineered wood veneer surfaced laminate; and
curing said first and second resins.

2. A method as claimed in claim 1 in which the veneer is a natural wood veneer.

3. A method as claimed in claim 1 in which the veneer is an engineered wood veneer.

4. A method as claimed in claim 1 in which said first liquid curable resin comprises melamine, formaldehyde, water, a base, a curing catalyst and at least one plasticizer or surfactant.

5. A method as claimed in claim 4 in which said first liquid curable resin is applied onto both the top and bottom surfaces of said sheet.

6. A method as claimed in claim 1 in which said first liquid curable resin is allowed to impregnate said sheet for approximately 10 to 60 minutes to substantially completely penetrate said sheet.

7. A method as claimed in claim 6 in which said first liquid curable resin is allowed to impregnate said sheet for approximately 20 to 40 minutes to substantially completely penetrate said sheet.

8. A method as claimed in claim 1 further including drying said first liquid curable resin prior to coating said second liquid curable resin onto said sheet.

9. A method as claimed in claim 1 in which said second liquid curable resin comprises a melamine-formaldehyde resin.

10. A method as claimed in claim 9 in which said second liquid curable resin includes a catalyst for curing said second resin.

11. A method as claimed in claim 9 in which said second liquid curable resin includes oxide particles.

12. A method as claimed in claim 1 in which said core comprises one or more sheets of resin impregnated paper.

13. A method as claimed in claim 12 in which said sheets of paper are selected from the group consisting of color dyed paper and pigmented paper.

14. A method as claimed in claim 12 in which said sheets of paper are selected from the group consisting of kraft paper, bleached kraft paper, and alpha cellulose paper.

15. A method as claimed in claim 12 in which said resin comprises a substantially colorless and transparent resin.

16. A method as claimed in claim 12 in which said resin comprises a melamine resin.

17. A method as claimed in claim 1 in which said sheet is laminated to said core by positioning said sheet and said core between a pair of press plates and applying pressure thereto.

18. A method as claimed in claim 17 including heating said press plates and laminate components contained therein to a temperature of from between about 128° C. to about 136° C. and curing said resins for from about 10 to about 30 minutes at said temperature.

19. A method as claimed in claim 17 including imparting a grain structure to a surface of said laminate by providing at least one press plate having a woodgrain surface texture and applying pressure to said sheet and core.

20. A method as claimed in claim 1 including postforming said natural or engineered wood veneer laminate by heating said laminate and forming at least a portion of said laminate around a forming mold.

21. A method as claimed in claim 1 including bonding said wood veneer surfaced laminate to a substrate to form a laminate panel assembly.

22. A method as claimed in claim 21 in which said substrate is selected from the group consisting of medium density fiberboard, particleboard, oriented strand board, wafer board, and mineral fiber cement board.

23. A method as claimed in claim 1 further comprising inserting a barrier sheet impregnated with a third liquid curable resin between said sheet of natural or engineered wood veneer and said core.

24. A method as claimed in claim 23 in which said barrier sheet comprises a pigmented or dyed paper.

25. A method as claimed in claim 23 in which said barrier sheet comprises kraft paper, bleached kraft paper, or alpha cellulose paper.

26. A method as claimed in claim 23 in which said third curable liquid resin comprises a substantially colorless and transparent resin.

27. A method as claimed in claim 26 in which said third curable resin comprises a melamine resin.

28. A wood veneer surfaced laminate made by the process of claim 1.

29. A wood veneer surfaced laminate comprising a core, and a sheet of a natural or engineered wood veneer laminated to said core, said natural or engineered wood veneer substantially completely impregnated with a first cured resin, and with a second cured resin coating on said natural or engineered wood veneer.

30. A wood veneer surfaced laminate as claimed in claim 29 in which said first resin comprises a melamine resin.

31. A wood veneer surfaced laminate as claimed in claim 29 in which said second resin comprises a melamine resin.

32. A wood veneer surfaced laminate as claimed in claim 29 in which said sheet is a natural wood veneer.

33. A wood veneer surfaced laminate as claimed in claim 29 in which said sheet comprises an engineered wood veneer.

34. A wood veneer surfaced laminate as claimed in claim 29 in which said core comprises one or more sheets of resin impregnated paper.

35. A wood veneer surfaced laminate as claimed in claim 34 in which said sheets of paper are selected from the group consisting of color dyed paper and pigmented paper.

36. A wood veneer surfaced laminate as claimed in claim 34 in which said sheets of paper are selected from the group consisting of kraft paper, bleached kraft paper, and alpha cellulose paper.

37. A wood veneer surfaced laminate as claimed in claim 34 in which said resin comprises a substantially colorless and transparent resin.

38. A wood veneer surfaced laminate as claimed in claim 34 in which said resin comprises a melamine resin.

39. A wood veneer surfaced laminate as claimed in claim 29 further comprising a barrier sheet impregnated with a third cured resin between said sheet of natural or engineered wood veneer and said core.

40. A wood veneer surfaced laminate as claimed in claim 39 in which said barrier sheet comprises a pigmented or dyed paper.

41. A wood veneer surfaced laminate as claimed in claim 39 in which said barrier sheet comprises kraft paper, bleached kraft paper, or alpha cellulose paper.

42. A wood veneer surfaced laminate as claimed in claim 39 in which said third cured resin comprises a substantially colorless and transparent resin.

43. A wood veneer surfaced laminate as claimed in claim 42 in which said third cured resin comprises a melamine resin.

44. A wood veneer surfaced laminate as claimed in claim 29 in which said cured wood veneer surface has an embossed woodgrain texture therein.

45. A wood veneer surfaced panel assembly comprising a core, a sheet of a natural or engineered wood veneer laminated to said core, said natural or engineered wood veneer substantially completely impregnated with a first cured resin, a second cured resin coating on said natural or engineered wood veneer, and said wood veneer surfaced laminate bonded to a substrate to form said panel assembly.

46. A wood veneer surfaced panel assembly as claimed in claim 44 in which said substrate is selected from the group consisting of medium density fiberboard, particleboard, oriented strand board, wafer board, and mineral fiber cement board.
